(19) United States
(12) Patent Application Publication
(10) Pub. No.: US 2014/0057483 A1
(43) Pub. Date: Feb. 27, 2014

(54) BRIDGE FOR AN ELECTRICAL TERMINAL

(71) Applicant: Michael Reineke, Steinheim (DE)

(72) Inventor: Michael Reineke, Steinheim (DE)

(73) Assignee: Phonenix Contact GMBH & Co. KG, Blomberg (DE)

(21) Appl. No.: 14/008,836

(22) PCT Filed: Mar. 27, 2012
(86) PCT No.: PCT/EP2012/055384

§ 371 Date: Oct. 31, 2013

(30) Foreign Application Priority Data
Mar. 31, 2011 (DE) 102011001714.3

(51) Int. Cl. H01R 13/62

(52) U.S. Cl. CPC H01R 13/62
USPC 439/507

(57) ABSTRACT

A jumper for an electrical terminal for electrical connecting a conductor rail of the electrical terminal includes a head part and a resilient pair of clamp tongues that engage into an opening of the conductor rail. Each clamp tongue includes an inner side and an outer side. The outer sides form a contact area to contact the opening. The clamp tongues are biased with a spring load such that the inner sides of a pair of clamp tongues are arranged opposite to each other, and in a non-contact state are disposed spaced apart from each other. Each clamp tongue extends from the head part towards a tip. Each inner side has a contour such that in a contact state the clamp tongues abut against each other and a gap between the inner sides is formed between the head part and the tips.

### BACKGROUND OF THE DISCLOSURE

1. Field of the Disclosure

The invention relates to a jumper for an electrical terminal for electrical connecting conductor rails of the terminal as well as the electrical terminal comprising the conductor rail and the jumper.

2. Description of the Related Art

From prior art various jumpers are known which are also referred to as cross or plug connectors which enable an electrically conductive connection between conductor rails of two or more terminals, such as terminal blocks, terminal clamps and/or connection terminals.

From DE 44 14 148 jumpers are known, which consist of an overmoulding and a current-carrying member. The current-carrying member is made from a flat material and comprises at least two clamp tongues arranged in a U-shape which comprise at their free ends bulges in the form of a circular arc and can be attached onto the diameter of a round rod. The clamp tongues formed as spring arms thus create a two-dimensional contact force, which strongly decreases during the continuous operation due to production tolerances and the setting behaviour of the members, such that with increasing age of the jumper a sufficient contact, and thus electrical connection, can no longer be ensured. Furthermore, the jumpers known from DE 44 14 148 only have a very small contact zone for the contact of two potentials, which are located at the lower end of the spring arms, such that an extremely precise positioning of the jumper at the terminal is required in order to ensure a reliable contact.

Moreover, from DE 197 08 649 jumpers are known which are cut in one piece from a flat sheet material and respectively comprise an upper bridging bar from which at least two or more flat plug tongues extend in a comb-like manner. Each plug tongue is divided by a partition slot extending in the plug direction and disposed approximately centered into two contact legs which are resilient with respect to each other. However, even according to this teaching there arises a problem that the spring arms are becoming spread during the manufacturing process such that in the continuous operation the contact forces weaken due to the production tolerances and the setting behaviour of the members so that even this teaching does not ensure a long-term reliable contact.

### SUMMARY OF THE DISCLOSURE

It is an object of the invention to provide a jumper which on the one hand can be manufactured at low cost and on the other hand ensures a continuous reliable contact even in long-term use.

This object according to the invention is achieved by the features of the independent claims. Advantageous embodiments of the invention are described in the dependent claims.

Thus, the invention is achieved by a jumper for an electrical terminal for electrically connecting conductor rails of the terminal, wherein the jumper comprises a head part and at least one resilient pair of clamp tongues adapted to engage into an opening of the conductor rail, wherein the clamp tongues each comprise an inner side and an outer side, the outer sides respectively form a contact area adapted contact the opening, the clamp tongues respectively are connected to the head part and biased with a spring load such that the inner sides of one pair of clamp tongues are arranged opposite to each other and in the non-contact state of the pair of clamp tongues with respect to the conductor rail are disposed spaced apart from each other, the clamp tongues each extend from the head part towards a tip and the inner sides each have a contour configured such that in the contact state of the pair of clamp tongues with respect to the conductor rail the tips of the clamp tongues abut against each other and a gap between the inner sides is formed between the head part and the tips.

Thus, the invention adopts a new approach in that in contrast to the jumpers known from prior art the contact forces are increased by ensuring that in the contact state of the pair of clamp tongues with respect to the conductor rail only the tips of the clamp tongues abut against each other and thus mutually support each other and thereby stabilize the clamp tongues. According to a particularly preferred implementation the tips of the clamp tongues abut against each other such that they form a line-shaped and/or very small support area. Due to the fact that in the contact state of the pair of clamp tongues with respect to the conductor rail, i.e. in the engaged state of the pair of clamp tongues within the opening, a gap is formed between the inner sides, production tolerances of the clamp tongues can be compensated which in turn ensures a considerably improved contact between the clamp tongues and the conductor rail.

Most preferably the jumper is cut from a flat sheet material, such as copper pre-tinned galvanically or by hot-dip-galvanizing, wherein the clamp tongues are preferably formed as spring arms. According to the invention it is provided that the jumper in the case of application, i.e. if an electrically conductive connection is established between at least two conductor rails by means of the jumper, engages into the conductor rail by means of its clamp tongues such that an electrically conductive contact is established by the contact area with the conductor rail. Due to the fact that in this contact state between the jumper and the conductor rail the clamp tongues at their free ends, i.e. at the tips, mutually support each other and a gap is formed between the free ends and the head part, in contrast to the prior art a complete different principle is applied which results in a substantially improved contact between the jumper and the terminal even after many plug-in events of the jumper into the opening. In other words, the jumper of the present invention is configured such that in the contact state between the clamp tongues and the conductor rail the tips of the clamp tongues abut against each other while in the non-contact state the tips do not abut against each other, wherein both in the contact state and in the non-contact state between the head part and the tips a gap is formed between the inner sides.

Principally, the contour of the inner side can be arbitrarily configured for forming the slot. However, according to a particularly preferred embodiment of the invention it is provided that the inner side comprises a lens-like and/or curved contour. According to another preferred embodiment it is provided that the inner sides have such a contour that in the contact state of the pair of clamp tongues with respect to the conductor rail the gap between the inner sides has an oval shape. According to such configurations of the inner sides and their contours, respectively, it can be ensured, that the clamp tongues in the plugged-in state can be stabilized particularly well resulting in a very stable and reliable contact between the jumper and the conductor rail.

According to another preferred embodiment of the invention it is provided that the contact area is configured such that in the contact state of the pair of clamp tongues with respect to the conductor rail the pair of clamp tongues can be displaced in the insertion direction within the opening. This means, that according to this preferred embodiment of the invention the pair of clamp tongues and, thus, the jumper can be displaced within the opening without interrupting the contact, i.e. the electrical contact, between the jumper and the conductor rail. In other words, this embodiment ensures in a particularly preferred way against the prior art that the jumper can not only be positioned at a single position, but at different positions at the conductor rail along the contact area for establishing the electrical connection, wherein the different positions can be achieved by displacing the jumper in the insertion direction within the opening. In this way the adverse effect of production tolerances is substantially reduced such that the jumper in different “immersion depth” in the opening ensures a stable and reliable electrical contact between the jumper ant the conductor rail. Preferably the contact areas associated to the clamp tongues of one pair of clamp tongues in the contact state are disposed parallel to each other and respectively extend over a length from a few millimeters up to a few centimeters, for example from 1, 2, 3, 4 or 5 mm up to 1, 2, 3, 4 or 5 centimeters along the outer side of the clamp tongues.

Principally, as already stated, the jumper can be configured arbitrarily, however, preferably it is cut out from a metal. According to a further particularly preferred embodiment of the invention, however, an insulating overmoulding in the area of the head part of the jumper is provided. This overmoulding is preferably formed from an insulating material such as plastics and is particularly preferred formed as a cap by means of which the jumper can be plugged on and removed from the conductor rail even without the use of an insulating tool.

According to a further preferred embodiment a predetermined breaking point is respectively provided between the head part and the clamp tongue. Furthermore it is preferred that a stem is provided between the head part and the pair of clamp tongues and the head part, the stem and the pair of clamp tongues are formed integrally. Particularly preferred a plurality of pairs of clamp tongues are provided. This enables to manufacture various configurations of jumpers by breaking out the clamp tongues which are not required for a cross connection by means of the predetermined breaking point such that, for example, a cross connection between two conductor rails can be established which are separated from each other by a third conductor rail. Moreover, it is preferred that the overmoulding is also provided at the stem such that the jumper can be handled particularly safe by gripping the overmoulding while preventing any contact with potentially current-carrying parts of the jumper.

The object of the invention is further achieved by an electrical terminal comprising a current rail and a jumper, as described above, wherein the pair of clamp tongues is configured such that in the contact state of the pair of clamp tongues with respect to the opening the pair of clamp tongues abut clampingly against the opening.

Such a terminal including a jumper according to the invention enables a particular stable, easy and inexpensive way for establishing a long-term reliable electrical contact between the jumper and a conductor rail of the electrical terminal Preferably the opening and/or the clamp tongues of a pair of clamp tongues corresponding to the opening are configured such that in the connected state of the pair of clamp tongues with respect to the opening the outer dimension of the pair of clamp tongues corresponds to the inner dimension of the opening.

According to a further preferred embodiment it is provided that the pair of clamp tongues are configured such that the pair of clamp tongues in the contact state with respect to the conductor rail clampingly abut against the opening when the pair of clamp tongues is displaced in the insertion direction within the opening. This configuration ensures that the pair of clamp tongues establishes a stable connection between the jumper and the terminal not only at a single position, but enables a reliable and stable contact between the jumper and the terminal along a contact area extending in the insertion direction.

### BRIEF DESCRIPTION OF THE DRAWINGS

In the following, the invention is described in more detail with respect to the accompanying drawings with reference to a preferred embodiment. In the drawings:

FIG. 1 shows a jumper comprising an overmoulding according to a preferred embodiment of the invention;

FIG. 2 shows the jumper without overmoulding according to the preferred embodiment of the invention;

FIG. 3a shows a part of the jumper in a first contact state with respect to a conductor rail according to the preferred embodiment of the invention;

FIG. 3b shows a part of the jumper in a second contact state with respect to a conductor rail according to a further preferred embodiment of the invention; and

FIG. 4 shows a partial view of the jumper in a contact state with respect to two conductor rails according to a further preferred embodiment of the invention.

### DESCRIPTION OF THE DISCLOSURE

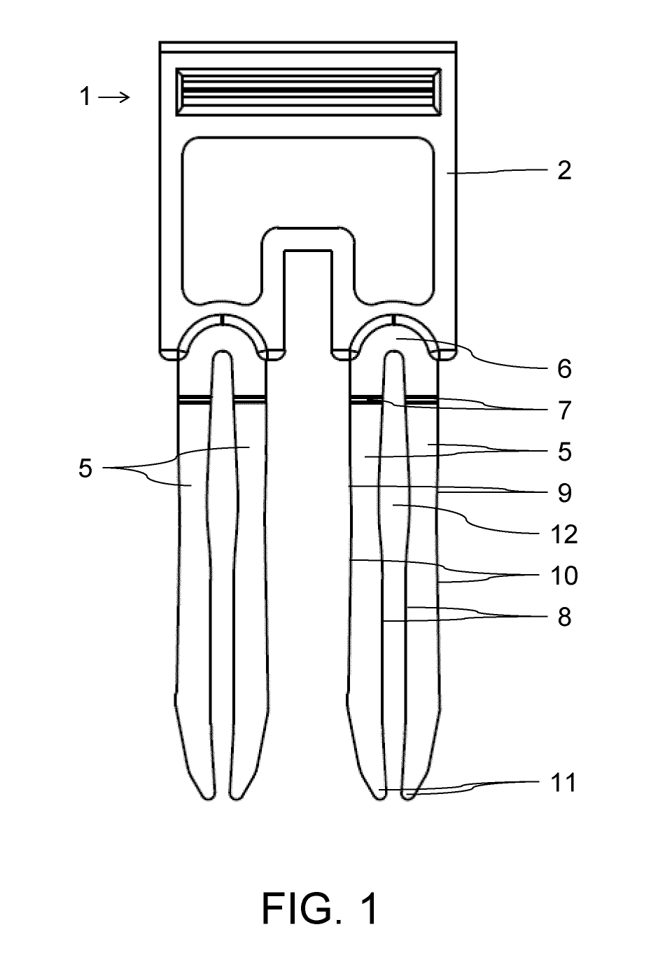

FIGS. 1 to 4 show schematic views of a jumper according to a preferred embodiment of the invention.

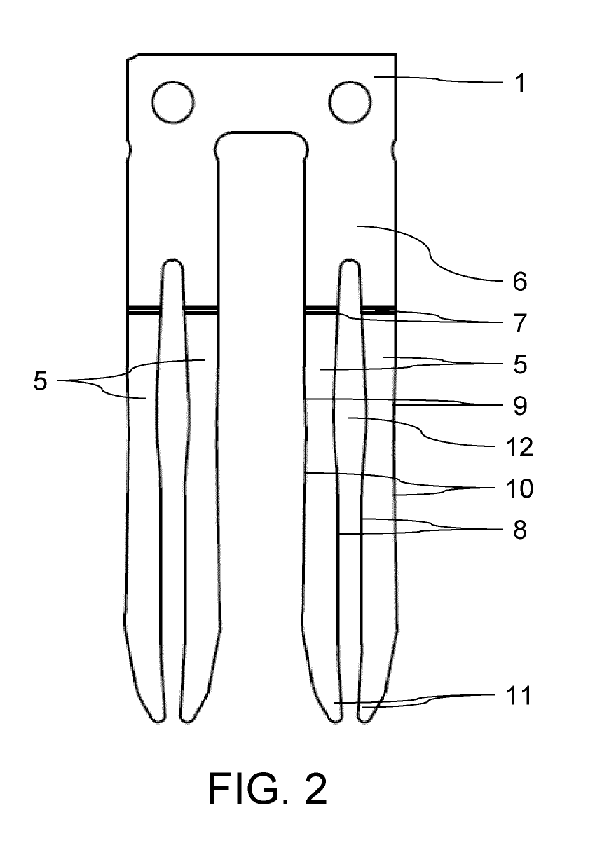

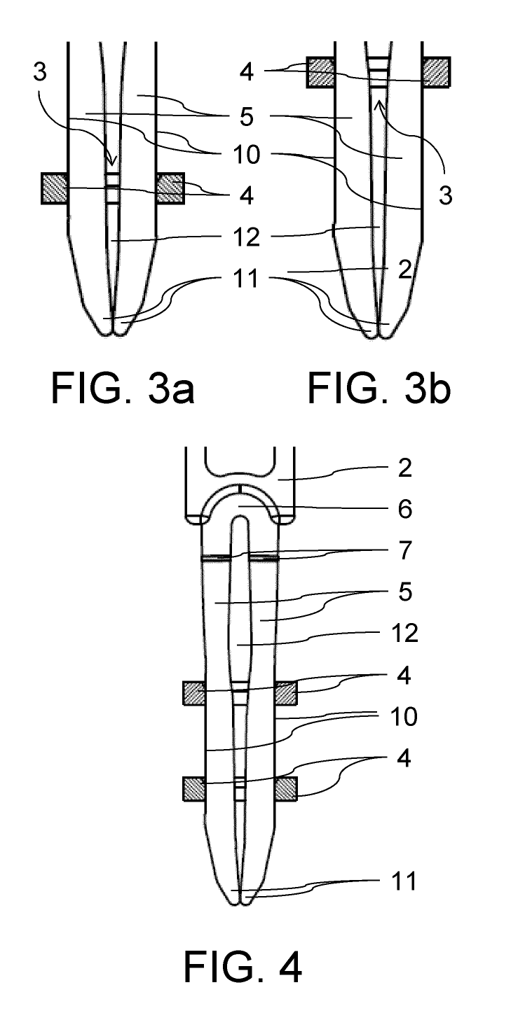

FIG. 1 shows a jumper according to the invention for an electrical terminal, wherein the jumper comprises a head part 1, which in the present embodiment is overmoulded with an overmoulding 2 made of an insulating material to enable an operator to grip the jumper at its head part 1 without the risk of coming into contact with a current-carrying part of the jumper. The jumper can be inserted into an opening 3 of a conductor rail 4, as shown in FIGS. 3a and 3b, and FIG. 4, and can be removed from the opening 3. In this regard FIG. 2 shows the jumper according to the invention without the overmoulding 2, wherein a stem 6 is provided between the head part 1 and both pairs of clamp tongues 5 respectively extending away from the head part 1.

Between the stem 6 and the clamp tongues 5 a respective predetermined breaking point 7 associated to the clamp tongue 5 is provided, such that a clamp tongue 5 or a pair of clamp tongues 5, as required, can be removed from the jumper by breaking out.

The head part 1, the stem 6 and both pairs of clamp tongues 5 are formed integrally from copper pre-tinned galvanically or by hot-dip-galvanizing and preferably manufactured by cutting out from a metal sheet. In this way, when the jumper with its pairs of clamp tongues 5 is inserted into the conductor rail 4 of a terminal, such that the pairs of clamp tongues 5 abut against the conductor rail 4, as seen in FIG. 3 or FIG. 4, an electrically conducting connection between the conductor rail 4 associated to the respective pair of clamp tongues 5 can be established.

The clamp tongues 5 each comprise an inner side 8 and an outer side 9, wherein the inner sides 8 of one pair of clamp tongues 5 are arranged oppositely to each other. The pair of clamp tongues 5 are formed resiliently, such that in a non-contact state with respect to a conductor rail 4 they are arranged spaced apart from each other, as seen in FIG. 1 and FIG. 2.

When the jumper is inserted into an opening 3 of a conductor rail 4, as shown in FIGS. 3a and 3b, and FIG. 4, the outer sides 9 abut against the conductor rail 4 and thus cause an electrically conducting connection between the clamp tongues 5 and the conductor rail 4. Herein the outer sides 9 respectively form a contact area 10, such that even if the pair of clamp tongues 5 is displaced within the opening 3 along the contact area 10 in the insertion direction of the pair of clamp tongues 5 into the opening 3 both at a first position, shown in FIG. 3a, and in at least a second position, shown in FIG. 3b, an electrically conducting connection between the jumper and the terminal is established. Thus, the contact area 10 is configured such, that the pair of clamp tongues 5 can be moved within the opening 3 in the insertion direction, while the electrical contact between the jumper and the terminal is not interrupted.

The inner sides 8 according to the invention are formed such that in the contact state of the pair of clamp tongues 5 with respect to the opening 3 the tips 11 of the pair of clamp tongues 5 abut against each other, such that between the head part 1 and the tips 11 a gap 12 between the inner sides 8 of the clamp tongues 5 is formed. Herein, as shown in FIG. 4, the gap 12 and the inner sides 8, respectively, are formed such that the inner sides 8 have a lens-like and/or curved contour.

Because the tips 11 of the pair of clamp tongues 5 in the contact state of the jumper with respect to the conductor rail 4 abut against each other and in the area between the head part 1 and the tips 11 a gap 12 is formed between the inner sides 8, due to the resilient configuration of the clamp tongues 5 even for production tolerances of the clamp tongues 5 a stable and reliable contact between the contact areas 10 and the conductor rail 4 is ensured even over a long time. Likewise, the jumper according to the invention due to the elongated configuration of the contact area 10 can enable an electrical connection between two different conductor rails 4.

### LIST OF REFERENCE SYMBOLS

1 Head part
2 Overmoulding
3 Opening
4 Conductor rail
5 Clamp tongues
6 Stem
7 Predetermined breaking point
8 Inner side
9 Outer side
10 Contact area
11 Tip
12 Gap

1. A jumper for an electrical terminal for electrical connecting a conductor rail of the electrical terminal,
wherein the jumper comprises a head part and at least one resilient pair of clamp tongues adapted to engage into an opening of the conductor rail, and
wherein
the clamp tongues each comprise an inner side and an outer side,
the outer sides respectively form a contact area adapted to contact the opening,
the clamp tongues respectively are connected to the head part and biased with a spring load such that the inner sides of a the non-contact state of the pair of clamp tongues with respect to the conductor rail are disposed spaced apart from each other,
the clamp tongues each extend from the head part towards a tip, and
the inner sides each have a contour configured such that in a contact state of the pair of clamp tongues with respect to the conductor rail the tips of the clamp tongues abut against each other and a gap between the inner sides is formed between the head part and the tips.

2. The jumper according to claim 1, wherein the inner side has a lens-like and/or curved contour.

3. The jumper according to claim 1, wherein the inner sides have a contour configured such that in the contact state of the pair of clamp tongues with respect to the conductor rail the gap between the inner sides has an oval shape.

4. The jumper according to claim 1, wherein the contact area is configured such that in the contact state of the pair of clamp tongues with respect to the conductor rail the pair of clamp tongues can be displaced within the opening in the insertion direction.

5. The jumper according to claim 1, including an insulating overmoulding, wherein the overmoulding is arranged in the area of the head part.

6. The jumper according to claim 1, wherein between the head part and the clamp tongue respectively a predetermined breaking point is provided.

7. The jumper according to claim 1, wherein a stem is provided between the head part and the pair of clamp tongues, and wherein the head part, the stem and the pair of clamp tongues are formed integrally.

8. The jumper according to claim 1, wherein a plurality of pairs or clamp tongues are provided.

9. An electrical terminal comprising a conductor rail and a jumper according to claim 1, wherein the pair of clamp tongues are configured such that in the contact state of the pair of clamp tongues with respect to the conductor rail the pair of clamp tongues clampingly abut against the opening.

10. The electrical terminal according to claim 9, wherein the pair of clamp tongues are configured such that in the contact state of the pair of clamp tongues with respect to the conductor rail the pair of clamp tongues clampingly abut against the opening even if the pair of clamp tongues are displaced within the opening in the insertion direction.
